(19) United States
(12) Patent Application Publication
(10) Pub. No.: US 2022/0136424 A1
(43) Pub. Date: May 5, 2022

(54) Internal Combustion Engine Exhaust Aftertreatment System

(71) Applicant: International Engine Intellectual Property Company, LLC, Lisle, IL (US)

(72) Inventor: Bradley Jay Adelman, Chicago, IL (US)

(73) Assignee: International Engine Intellectual Property Company, LLC

(21) Appl. No.: 17/088,521

(22) Filed: Nov. 3, 2020

(51) Int. Cl. F01N 3/20; F01N 3/10; F01N 3/28; F01N 3/021; F01N 3/08; B01D 53/94; B01F 5/06

(52) U.S. Cl. CPC F01N 3/2066; B01D 2255/904; F01N 3/2803; F01N 3/2892; F01N 3/021; F01N 3/105; F01N 3/0842; F01N 3/085; B01D 53/944; B01D 53/9418; B01D 53/9477; B01D 53/9495; B01D 53/9436; B01F 5/0602; F01N 2610/1453; F01N 2610/02; F01N 2610/1406; F01N 2510/06; F01N 2370/04; B01D 2255/1023; B01D 2255/50; F01N 3/103

(57) ABSTRACT

An engine exhaust aftertreatment system having an organization and arrangement of certain selected components which achieve significant catalytic reduction of the known NOx pollutants (NO and NO₂) in tailpipe-out exhaust, while also achieving significant catalytic reduction of sulfate pollutants in tailpipe-out exhaust.

### TECHNICAL FIELD

This disclosure relates to an engine exhaust aftertreatment system of a motor vehicle, such as a heavy truck for example, which is powered by an internal combustion engine, such as a turbocharged diesel engine for example.

### BACKGROUND

One technology for aftertreatment of diesel engine exhaust utilizes selective catalytic reduction (SCR) to enable known chemical reactions which convert NOx into nitrogen (N₂) and water (H₂O), two constituents found in abundance in earth's atmosphere. A reaction may occur between only two reactants: 1) ammonia (NH₃) stored on surface sites of a selective catalytic reduction (SCR) catalyst and NOx in the exhaust; or 2) those two reactants and an additional reactant, oxygen (O₂), if the latter is also present in the exhaust. Ammonia molecules reduce NOx by the following known chemical reactions:

4NO+4NH₃+O₂→4N₂+6H₂O

NO+NO₂+2NH₃→2N₂+3H₂O

6NO₂+8NH₃→7N₂+12H₂O

For attaining compliance with applicable tailpipe emission standards, today's vehicles which are propelled by diesel engines commonly use diesel exhaust fluid (DEF). DEF is known by other names such as AdBlue and AUS325 in certain geographic regions. DEF is a liquid solution 32.5 wt % urea dissolved in 67.5 wt % de-ionized water.

DEF is stored in a DEF storage tank on board a vehicle. The DEF storage tank is typically exposed to weather, and DEF in the tank will freeze when outside temperature falls below the DEF freezing point and the engine does not operate for an extended length of time. The specific 32.5%/67.5% DEF formulation provides DEF with a eutectic concentration where urea and water freeze/thaw at the same temperature, namely −12° C. (10° F.). In mixtures having urea concentrations greater than 32.5%, urea, but not water, freezes at temperatures different from the temperature at which the 32.5%/67.5% concentration freezes, and in mixtures having urea concentrations less than 32.5%, water, but not urea, freezes at temperatures different from the temperature at which the 32.5%/67.5% freezes.

While the water constituent of DEF provides a liquid medium in which urea will readily dissolve, the water needs to be evaporated by engine exhaust heat in order to release urea, and then the urea needs engine exhaust heat to decompose into ammonia so that ammonia molecules can attach to catalytic sites on washcoat surfaces of an SCR catalyst in the aftertreatment system and become available to reduce NOx in exhaust passing across those surfaces by catalytic conversion to N₂ and H₂O.

An example of an aftertreatment system which uses DEF is disclosed in US Patent Publication No. 2019/0234283. Engine-out exhaust operates a turbine of an engine turbocharger, such as a waste gate turbocharger. A shaft couples the turbine with a compressor in the engine intake system. The turbine converts waste heat in engine exhaust into mechanical energy which operates the compressor via the shaft to develop positive engine intake manifold pressure, i.e. to create boost. Consequently, when the turbine is operating the compressor, the temperature of turbine-out exhaust is lower than the temperature of engine-out exhaust. It is turbine-out exhaust which enters the aftertreatment system, and the temperature of turbine-out exhaust is a significant parameter which affects how the aftertreatment system functions. Engine-out exhaust temperatures are seldom in excess of about 500° C. (the minimum regeneration temperature), and turbocharger-out temperatures are even lower.

The aftertreatment system described in the above-mentioned Patent Publication has a conventional diesel oxidation catalyst (DOC) through which engine-out exhaust passes after having entered the aftertreatment system. The catalytic material is a metal zeolite known to have catalytic properties, such as a copper/zeolite-based formulation or a hybrid formulation which contains some copper/zeolite and one or more components such as iron or vanadium. The DOC promotes chemical oxidation of carbon monoxide and hydrocarbons and also removes certain entrained matter, such as the soluble organic fraction of diesel particulate matter before the exhaust flow from the DOC enters and passes through a diesel particulate filter (DPF).

From time to time the DPF is actively regenerated to remove trapped matter. Placement of the conventional DOC upstream of the DPF enables an exotherm for actively regenerating the DPF to be created. Active regeneration is performed by temporarily elevating the temperature of exhaust passing through the DPF to a sufficiently high temperature for removing a significant quantity of trapped matter. Post-injection of fuel into the engine cylinders after main in-cylinder combustion events, and by injection of fuel into the engine-out exhaust are ways to elevate exhaust temperature.

After the exhaust flow leaves the DPF, DEF is injected into the exhaust flow through the aftertreatment system in quantity controlled in relation to certain engine operating parameters, including exhaust temperature downstream of the DPF, in order to mitigate both ammonia slip and the formation of deposits on surfaces of downstream aftertreatment components, at least one of which is an SCR catalyst having surfaces across the exhaust flow passes after injected DEF has entrained with the exhaust flow, the water component of the DEF has been vaporized to release urea, and the released urea has been converted into ammonia. The catalytic material of the SCR catalyst, like that of the DOC, is a metal/zeolite-based formulation known to have catalytic properties or a hybrid formulation containing such a metal/zeolite.

Flowing injected DEF and engine exhaust through a mixer may mitigate formation of deposits to some extent by improving the conversion of DEF to the desired reductant, ammonia, but adequate path length for flow through a mixer may be constrained by available packaging space for the aftertreatment system in a particular vehicle, or a mixer may have an undesired restrictive effect on exhaust flow. While aftertreatment regeneration events will decompose or react away deposits, more frequent use of such events to mitigate deposit formation can reduce fuel efficiency and shorten exhaust aftertreatment system life. If ammonia slip cannot be limited to less than a specified tailpipe-out quantity of ammonia, an ammonia slip catalyst (ASC) downstream of an SCR catalyst may be needed.

While the aftertreatment system which has just been described can comply with certain tailpipe-out emission standards, the system seems unlikely to be capable of achieving compliance with stricter standards on certain emission constituents, including both NOx and sulfates, without further improvements.

### SUMMARY OF THE DISCLOSURE

This disclosure introduces a novel engine exhaust aftertreatment system in a motor vehicle which is powered by an internal combustion engine.

Briefly, the disclosed exhaust aftertreatment system comprises a novel organization and arrangement of certain selected components which achieve significant catalytic reduction of the known NOx pollutants (NO and NO₂) in tailpipe-out exhaust, while also achieving significant catalytic reduction of sulfate pollutants in tailpipe-out exhaust.

One general aspect of the claimed subject matter relates to a motor vehicle comprising a diesel engine having an engine exhaust aftertreatment system which has an entrance through which diesel exhaust coining from the engine enters the aftertreatment system, an exhaust flow path for treating diesel exhaust which has entered the aftertreatment system as diesel exhaust flows along the exhaust flow path, and an exit through which treated diesel exhaust exits the aftertreatment system.

The exhaust flow path contains, seriatim from the entrance: 1) a first DOC for catalytic treatment of engine-out exhaust, the first DOC having catalytic material in a non-catalytic washcoat which has been applied to a non-catalytic substrate, the catalytic material consisting essentially of elemental palladium and being essentially free of constituents for catalytically converting NO to NO₂ and SO₂ to SO₃ 2) a first mixing chamber space and a first DEF injector for injecting DEF into exhaust flow passing through the first mixing chamber space from the first DOC, 3) a first SCR catalyst comprising a metal/zeolite for treating exhaust flow coining from the first mixing chamber space, 4) a DPF, 5) a second mixing chamber space and a second DEF injector for injecting DEF into exhaust flow coining from the DPF, and 6) a second SCR catalyst comprising a metal/zeolite for treating exhaust coining from the second mixing chamber space.

At least one tank for storing DEF which is to be injected by the first and second DEF injectors.

A controller for controlling quantities of DEF injected by the first DEF injector and by the second DEF injector.

Another general aspect of the claimed subject matter relates to a method by which the claimed aftertreatment system treats diesel exhaust.

The foregoing summary is accompanied by further detail of the disclosure presented in the Detailed Description below with reference to the following drawings which are part of the disclosure.

### BRIEF DESCRIPTION OF THE DRAWINGS

FIG. 1 shows a motor vehicle which is propelled by an internal combustion engine.

FIG. 2 is a general schematic diagram of the engine and its exhaust aftertreatment system.

### DETAILED DESCRIPTION

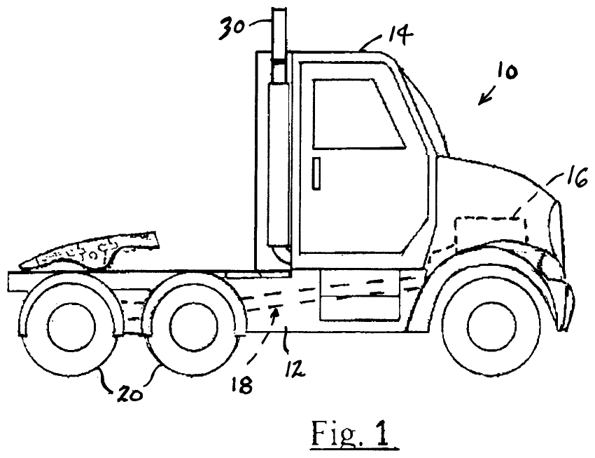

FIG. 1 shows a truck vehicle 10, such as a highway tractor for example, having a chassis 12 and a cab 14 supported on a frame of chassis 12 which also supports a fuel-consuming engine 16 of a powertrain 18. Engine 16 operates through a drivetrain of powertrain 18 to tandem axle drive wheels 20 which propel the truck vehicle on an underlying surface such as a roadway.

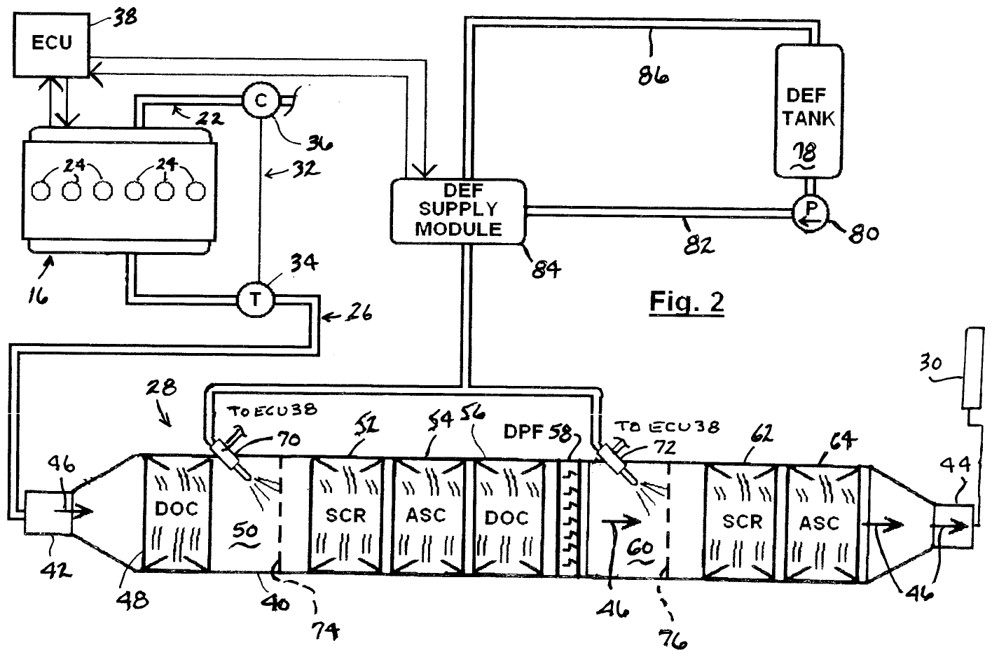

FIG. 2 shows a portion of an engine intake system 22 for conveying air to cylinders 24 of engine 16 into which fuel is injected and within which injected fuel is combusted to operate the engine. It also shows a portion of an engine exhaust system 26 which includes an exhaust aftertreatment system 28 which treats exhaust resulting from combustion of fuel in cylinders 24, i.e. “engine-out” exhaust, as the exhaust flows through the aftertreatment system before treated exhaust exits the aftertreatment system to pass through and out of a tailpipe 30 into surrounding atmosphere.

Engine 16 is representative of a turbocharged diesel engine which comprises a turbocharger 32 having a turbine 34 operated by engine-out exhaust before exhaust enters aftertreatment system 28. Turbine 34 operates a compressor 36 to create charge air which enters cylinders 24 from intake system 22, and in doing so decreases. Other components associated with this type of engine, such as a charge air cooler, an air filter, etc. for example, are not shown in the drawing.

An engine controller comprises a processor-based engine control unit (ECU) 38 which controls various aspects of engine operation, such as injection of fuel into engine cylinders 24. Control of fuel injection and other functions is accomplished by processing various input data to develop control data for controlling those functions.

Exhaust aftertreatment system 28 is shown in FIG. 2 to comprise structure through which exhaust is constrained to pass before exiting exhaust system 26. It should be understood that various components of the illustrated structure are shown schematically rather than as actual components, many of which are well-known in aftertreatment systems. Aftertreatment system 28 comprises an enclosure 40 providing an exhaust flow path between an exhaust entrance 42 at an upstream end, and an exhaust exit 44 at a downstream end. Arrows 46 indicate a direction of exhaust flow into, through, and out of the interior of enclosure 40. After passing through entrance 42, the exhaust flow is constrained to pass in succession across surfaces of a first DOC 48 (preferably a close-coupled DOC), then through a first mixing chamber space 50, and then across surfaces of a first SCR catalyst 52, of a first ASC 54, and of a second DOC 56 before arriving at a DPF 58. Downstream of DPF 58, the exhaust flow passes first through a second mixing chamber space 60 and then in succession across surfaces of a second SCR catalyst 62 and of a second ASC 64.

Enclosure 40 may be mounted on a frame rail of chassis 12, or alternately, certain components of aftertreatment system 28 may be housed within individual enclosures which are connected into the system by pipes.

DOC 48 treats engine exhaust by removing certain entrained matter and promoting chemical reaction of certain exhaust constituents, as mentioned earlier. First SCR catalyst 52 promotes further chemical reactions of certain constituents, primarily NOx, and first ASC 54 promotes reactions which convert ammonia into non-pollutant gases.

DPF 58 traps entrained soot to remove the trapped soot from the exhaust flow. Second SCR catalyst 62 promotes chemical reactions of certain exhaust constituents, and second ASC 64 promotes reactions which convert ammonia into non-pollutant gases, specifically nitrogen and water (vapor).

First SCR catalyst 52 is separated from DOC 48 by first mixing chamber space 50, and similarly, second SCR catalyst 62 is separated from DPF 58 by second mixing chamber space 60. DEF is introduced into each mixing chamber space via a respective DEF injector 70, 72 for entrainment and mixing with exhaust flow through the respective mixing chamber space. A mixing chamber space may, or may not, contain a physical element, such as a static mixer, which promotes wide distribution of mixing. Such physical elements are shown in phantom and marked by reference numerals 74, 76 in FIG. 2. Each DEF injector is also designed to promote wide distribution of DEF into the exhaust flow.

DEF is stored in a DEF storage tank 78 which is typically mounted on truck vehicle 10 at a location exposed to ambient temperatures which if low enough will freeze DEF in the DEF storage tank. When not frozen, DEF is drawn from DEF storage tank 78 by a pump 80 and delivered through a supply conduit 82 to a DEF supply module 84 at a pressure which is under control of ECU 38. Any excess of DEF delivered to DEF supply module 84 returns from the DEF supply module to the DEF storage tank through a return conduit 86.

ECU 38 monitors various relevant operating parameters of engine and measurements from various sensors associated with the aftertreatment system 28 to control operation of each DEF injector 70, 72 in coordination with control of DEF pressure so that proper quantities of DEF are injected into the respective mixing chamber spaces.

For complying with stricter tailpipe emission standards, Applicant had initially considered various modifications to the aftertreatment system of US Patent Publication No. 2019/0234283 before recognizing that the modifications failed to take the sulfur content of fuel into account.

For example, if a metal zeolite catalyst were placed upstream of the DPF, sulfur-based constituents present in untreated exhaust coining from the engine, sulfates would accumulate on surfaces of the catalyst, and over time, would lead to early catalyst failure with increasing accumulations on those surfaces because regeneration temperatures for removing them would not by sufficiently high, as mentioned earlier.

While it would be possible to de-sulfurize the upstream SCR catalyst by placing a close-coupled DOC (cc-DOC) upstream of the upstream SCR catalyst, and introducing hydrocarbons (HC) upstream of the cc-DOC, by post-injection of fuel into the engine cylinders after main combustion events and/or by injection of fuel into the engine-out exhaust, to create sufficiently high temperatures to de-sulfurize the SCR catalyst, the applicant has discovered that doing so would lead to one or more new and different problems because the cc-DOC contains platinum and/or a platinum/palladium formulation.

The presence of platinum alone or as an element of a catalytic formulation, such as platinum/palladium, will cause NO in engine-out exhaust to be oxidized to NO₂ and SO₂ to be oxidized to SO₃. If higher levels of NO₂ are introduced into the upstream SCR catalyst, it is possible that levels of N₂O will increase and in turn increase greenhouse gas (GHG) content of tailpipe-out exhaust. Increased levels of SO₃ entering the upstream SCR catalyst may increase the rate of the sulfur deposition on catalytic surfaces and create need for more frequent de-sulfurization events with consequent earlier failure of the upstream SCR catalyst.

The disclosed aftertreatment system avoids the potential problems with the modification just described because the catalytic material of the first DOC 48 consists essentially of elemental palladium and is essentially free of constituents for catalytically converting NO to NO₂ and SO₂ to SO₃. Palladium can oxidize hydrocarbons in exhaust and during active regeneration generates an exotherm sufficient to remove accumulated sulfur and nitrogen compounds from downstream components without oxidizing NO to NO₂ and without oxidizing SO₂ to SO₃.

DOC 48 comprises a substrate to which a washcoat containing elemental palladium has been applied. The substrate, commonly a ceramic, is constructed to provide an extensive surface area for supporting the washcoat which itself has dried to highly irregular shape further increasing the surface area of washcoat across which engine exhaust flows when passing through the DOC. Palladium is distributed throughout the washcoat for catalytically enabling chemical reactions between certain constituents of engine-out exhaust, such as reducing CO to CO₂ and oxidizing hydrocarbons, to occur. The washcoat material is a porous refractory oxide, such as aluminum oxide. Both the washcoat material and the substrate material are non-catalytic.

While the diesel engine is one example of an internal combustion engine, the disclosed aftertreatment system may be used on any internal combustion engine which runs lean of stoichiometric (i.e. any lean burn engine).

What is claimed is:

1. A motor vehicle comprising;
a diesel engine having an engine exhaust aftertreatment system which has an entrance through which diesel exhaust coining from the engine enters the aftertreatment system, an exhaust flow path for treating diesel exhaust which has entered the aftertreatment system as diesel exhaust flows along the exhaust flow path, and an exit through which treated diesel exhaust exits the aftertreatment system,
the exhaust flow path containing, seriatim from the entrance: 1) a first DOC for catalytic treatment of exhaust coining from the engine, the first DOC having catalytic material in a non-catalytic washcoat which has been applied to a non-catalytic substrate, the catalytic material consisting essentially of elemental palladium and being essentially free of constituents for catalytically converting NO to NO₂ and SO₂ to SO₃, 2) a first mixing chamber space and a first DEF injector for injecting DEF into exhaust flow passing through the first mixing chamber space from the first DOC, 3) a first SCR catalyst comprising a metal/zeolite for treating exhaust flow coining from the first mixing chamber space, 4) a DPF, 5) a second mixing chamber space and a second DEF injector for injecting DEF into exhaust flow coining from the DPF, and 6) a second SCR catalyst comprising a metal/zeolite for treating exhaust coining from the second mixing chamber space;
at least one tank for storing DEF which is to be injected by the first and second DEF injectors; and
a controller for controlling quantities of DEF injected by the first DEF injector and the second DEF injector.

2. A motor vehicle as set forth in claim 1 further comprising a first ASC catalyst through which exhaust coining from the first SCR catalyst passes before reaching the DPF, and a second ASC catalyst through which exhaust coining from the second SCR catalyst passes before reaching the exit.

3. A motor vehicle as set forth in claim 2 in which the first mixing chamber space comprises a first static mixer, and the second mixing chamber space comprises a second static mixer.

4. A motor vehicle as set forth in claim 1 in which the engine comprises a turbocharger having a turbine through which exhaust coining from the engine passes before entering the entrance of the exhaust aftertreatment system.

5. A method for aftertreatment of diesel exhaust coining from a diesel engine in a motor vehicle, the method comprising;
flowing diesel exhaust through an exhaust flow path extending between an entrance and an exit of an aftertreatment system containing, seriatim from the entrance: 1) a first DOC for catalytic treatment of exhaust coining from the engine, the first DOC having catalytic material in a non-catalytic washcoat which has been applied to a non-catalytic substrate, the catalytic material consisting essentially of elemental palladium and being essentially free of constituents for catalytically converting NO to NO₂ and SO₂ to SO₃, 2) a first mixing chamber space, while injecting DEF into exhaust flow passing through the first mixing chamber space from the first DOC, 3) a first SCR catalyst comprising a metal/zeolite for treating exhaust flow coining from the first mixing chamber space, 4) a DPF, 5) a second mixing chamber space, while injecting DEF into exhaust flow coining from the DPF, and 6) a second SCR catalyst comprising a metal/zeolite for treating exhaust coining from the second mixing chamber space before the exhaust reaches the exit;
and controlling quantities of DEF injected into the first mixing chamber space and the second mixing chamber space.

6. A method as set forth in claim 5 further comprising flowing exhaust coming from the first SCR catalyst through a first ASC catalyst before the exhaust reaches the DPF, and flowing exhaust coining from the second SCR catalyst through a second ASC catalyst passes before the exhaust reaches the exit.

7. A method as set forth in claim 6 further comprising using a first static mixer in the first mixing chamber space to mix DEF with exhaust, and using a second static mixer in the second mixing chamber space to mix DEF with exhaust.

8. A method as set forth in claim 5 further comprising flowing exhaust through a turbine of a turbocharger before exhaust enters the entrance of the exhaust aftertreatment system.
